(19) United States
(12) Patent Application Publication
(10) Pub. No.: US 2011/0255848 A1
(43) Pub. Date: Oct. 20, 2011

(54) APPARATUS AND METHOD FOR CONTROLLING HEATING LAMP OF RAPID HEAT TREATMENT EQUIPMENT

(76) Inventors: Sang Hyun Ji, Gyeonggi-do (KR); Dae Yong Lee, Gyeonggi-do (KR); Seung Hwan Lee, Gyeonggi-do (KR)

(21) Appl. No.: 13/132,674

(22) PCT Filed: Nov. 27, 2009
(86) PCT No.: PCT/KR09/07053

§ 371 Date: Jul. 6, 2011

(30) Foreign Application Priority Data
Dec. 5, 2008 (KR) 10-2008-0122932

(51) Int. Cl. F27D 11/00

(52) U.S. Cl. 392/411

(57) ABSTRACT

The method of the present invention for controlling a heating lamp of rapid heat treatment equipment comprises: a step wherein a heating lamp group is divided into a plurality of subgroups to determine graphical data regarding input voltage versus the reference input current that is applied to the subgroups uniformly; a step wherein actual input current respectively applied to each group is measured to obtain graphical data regarding input voltage versus actual input current; a step wherein a difference value for calibration of each subgroup is obtained from the difference between the reference input current and the actual input current; and a step wherein the difference value for calibration is reflected to apply a voltage to said subgroup individually. According to the present invention, substrate heating takes place uniformly because differences of calibration are reflected in actual input current to apply a voltage to a subgroup.

### TECHNICAL FIELD

The present invention relates to an apparatus and method for controlling heat lamps of rapid heat treatment equipment. More particularly, the present invention relates to an apparatus and method for controlling heat lamps of rapid heat treatment equipment, in which a group of heat lamps is divided into a plurality of subgroups such that electric power is independently supplied to each of the subgroups to enhance heating uniformity during rapid heat treatment of a substrate.

### BACKGROUND ART

Rapid heat treatment equipment heats a substrate through a plurality of heat lamps. Here, although the heat lamps are manufactured by the same company, there is a slight difference in heating characteristics therebetween. Currently, the difference in heating characteristics between the heat lamps is not calibrated.

FIG. 1 is a graph illustrating a difference in heating characteristics between heat lamps. As shown in FIG. 1, although Lamp 1, Lamp 2 and Lamp 3 are manufactured by the same company, there can be a slight difference between graph data of input voltage to input current. Herein, the term “graph data of input voltage to input current” refers to pairs of coordinates of input voltage to input current, which can be depicted by a graph such that the statistic values can be visually ascertained. If such heat lamps are used together in actual rapid heat treatment, Lamp 1, Lamp 2 and Lamp 3 generate different quantities of heat even when the same voltage is applied thereto. Conventionally, a plurality of heat lamps is commonly controlled based on a single data graph of input voltage to reference input current without considering the difference of the heating characteristics between the lamps. In this case, data of input voltage to reference input current may be provided by Lamp 1 or Lamp 2 according to user selection. Typically, average data from a plurality of heat lamps can be used. Accordingly, even when the same voltage is applied to the respective lamps, the substrate can be non-uniformly heated due to different output quantities of the heat lamps.

### DISCLOSURE

### Technical Problem

Aspects of the present invention provide an apparatus and method for controlling heat lamps of rapid heat treatment equipment, which control the heat lamps in consideration of input current offset occurring between the heat lamps due to an error in manufacture of the heat lamps, such that heat is uniformly generated from the heat lamps.

### Technical Solution

In accordance with one aspect of the invention, a method for controlling heat lamps of rapid heat treatment equipment relates to a rapid heat treatment process in which a group of heat lamps is divided into a plurality of subgroups and electric power is supplied to each of the subgroups to heat a substrate. More particularly, the method includes: determining graph data of input voltage-reference input current commonly applied to the subgroups; measuring actual input current applied to each of the subgroups when electric power is supplied to each of the subgroups to obtain graph data of input voltage-actual input current; calculating a difference between the reference input current and the actual input current to obtain a calibration value for each of the subgroups; and applying voltage to each of the subgroups according to the corresponding calibration value for each of the subgroups.

In accordance with another aspect of the invention, an apparatus for controlling heat lamps of rapid heat treatment equipment relates to rapid heat treatment equipment which includes a group of heat lamps divided into a plurality of subgroups and supplies electric power to each of the subgroups to heat a substrate. More particularly, the apparatus includes: a plurality of power control boards disposed in one-to-one correspondence with the subgroups to supply voltage to the subgroups; a plurality of current measuring units disposed between the power control boards and the subgroups so as to be in one-to-one correspondence therewith and measuring actual input current flowing to the subgroups; and a main controller integrated into the plurality of power control boards to communicate with the plurality of power control boards, wherein, when actual input current measured by the current measuring units is fed back to the power control boards, the power control boards send the fed-back actual input current to the main controller, the main controller calculates a difference between reference input current and the actual input current to obtain a calibration value for each of the subgroups by comparing graph data of input voltage-reference input current with graph data of input current-actual input current and sends the calibration value to the corresponding power control boards, and the power control boards apply voltages to the corresponding subgroups according to the corresponding calibration values to uniformly heat a substrate during rapid heat treatment.

### Advantageous Effects

According to an exemplary embodiment, a calibration value for each of the subgroups with respect to graph data of input voltage-reference input current is previously obtained and actual input current applied to each of the subgroups in actual heat treatment is then fed back to the power control boards such that the power control boards supply voltage to each of the subgroups by reflecting the calibration value to the actual input current, thereby enabling uniform heating of a substrate.

### DESCRIPTION OF DRAWINGS

FIG. 1 is a graph illustrating a difference in heating characteristics between heat lamps;

FIG. 2 is a view of an apparatus for controlling heat lamps of rapid heat treatment equipment according to an exemplary embodiment of the present invention; and

FIG. 3 is a flowchart of a method of controlling heat lamps of rapid heat treatment equipment according to an exemplary embodiment of the present invention.

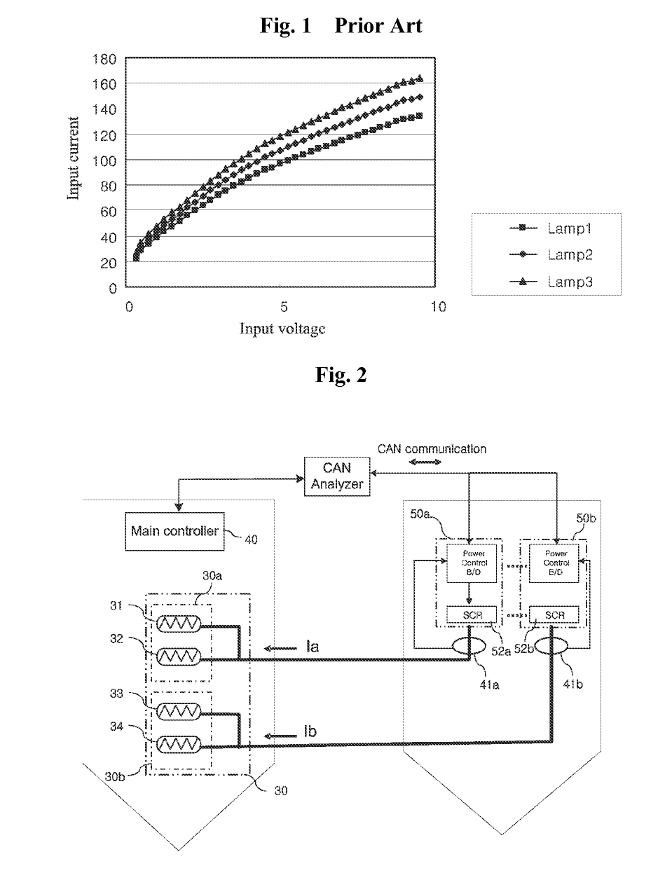

### MODE FOR INVENTION

Exemplary embodiments of the invention will be described in detail. However, it should be understood that the embodiments are given to provide thorough understanding of the invention to those skilled in the art and may be embodied in different ways. Thus, the present invention should not be construed as being limited thereto. Herein, the term “graph data” refers to pairs of coordinates of input voltage to input current, which can be depicted by a graph, as defined in the description of the background art.

FIG. 2 is a view of an apparatus for controlling heat lamps of rapid heat treatment equipment according to an exemplary embodiment of the invention, and

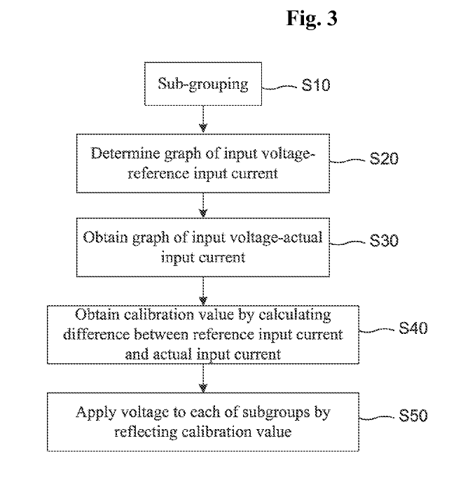

FIG. 3 is a flowchart of a method of controlling heat lamps of rapid heat treatment equipment according to an exemplary embodiment of the invention.

Referring to FIGS. 2 and 3, a heat lamp group 30 comprising a plurality of heat lamp 31, 32, 33, 34 is divided into a plurality of subgroups 30a, 30b, and power control boards 50a, 50b are respectively connected to the subgroups 30a, 30b (S10). In other words, electric power is independently supplied to each of the subgroups 30a, 30b. A main controller 40 stores a single data graph of input voltage-reference input current to commonly control the subgroups 30a, 30b (S20).

Compensation

Compensation is performed before performing actual heat treatment. This operation is performed to calibrate a difference in voltage-current characteristics between the subgroups 50a, 50b.

When the main controller 40 controls each of the power control boards 50a, 50b to supply an input voltage of 0 to 10V to the subgroups 30a, 30b, actual input current Ia and Ib flows through each of the subgroups 30a, 30b. The actual input current Ia and Ib input to each of the subgroups 30a, 30b is measured by current transformers 41a, 41b provided as current measuring units (S30).

Here, the graph data of the actual input current Ia and Ib according to input voltage is slightly offset from the graph data of input voltage-reference input current due to a difference in light emitting characteristics resulting from an error in manufacture of the heat lamps 31 to 34 provided to the subgroups 30a, 30b.

The power control boards 50a, 50b receive the actual input current Ia and Ib measured by the current transformers 41a, 41b and send the actual input current to the main controller 40 via controller area network (CAN) communication. Then, the main controller 40 calculates a calibration value corresponding to a difference between the actual input current Ia and Ib and the reference input current for each of the subgroups 30a, 30b and sends the calibration value to the corresponding power control boards 50a, 50b (S40). Here, the different calibration values may be provided to the respective power control boards 50a, 50b.

If the graph data of input voltage-reference input current is stored in each of the power control boards 50a, 50b instead of the main controller 40, the power control boards 50a, 50b send the graph data of input voltage-actual input current together with the graph data of input voltage-reference input current to the main controller 40.

Rapid Heat Treatment

During the heat treatment, the current transformers 41a, 41b measure the actual input current flowing to each of the subgroups 30a, 30b and feed-back the measured actual input current to the power control boards 50a, 50b. Then, the power control boards 50a, 50b apply a corrected voltage to each of the subgroups 30a, 30b by reflecting the calibration value in the measured actual input current (S50). Then, different input currents flow through the respective subgroups 30a, 30b such that the respective subgroups 30a, 30b emit identical quantities of light. The power control boards 50a, 50b apply power to the respective subgroups 30a, 30b via an SCR 52.

As described above, according to the embodiment, a calibration value for each of the subgroups 30a, 30b with respect to graph data of input voltage-reference input current is previously obtained and actual input current applied to each of the subgroups 30a, 30b in actual heat treatment is then fed back to the power control boards 50a, 50b such that the power control boards 50a, 50b supply voltage to each of the subgroups 30a, 30b by reflecting the calibration value in the actual input current, thereby enabling uniform heating of a substrate.

1. A rapid heat treatment method using a group of heat lamps divided into a plurality of subgroups such that electric power is supplied to each of the subgroups to heat a substrate, the method comprising:
determining graph data of input voltage-reference input current commonly applied to the subgroups;
measuring actual input current applied to each of the subgroups when electric power is supplied to each of the subgroups to obtain graph data of input voltage-actual input current;
calculating a difference between the reference input current and the actual input current to obtain a calibration value for each of the subgroups; and
applying voltage to each of the subgroups according to the corresponding calibration value for each of the subgroups.

2. A rapid heat treatment apparatus using a group of heat lamps divided into a plurality of subgroups such that electric power is supplied to each of the subgroups to heat a substrate, the apparatus comprising:
a plurality of power control boards disposed in one-to-one correspondence with the subgroups to supply voltage to the subgroups;
a plurality of current measuring units disposed between the power control boards and the subgroups so as to be in one-to-one correspondence therewith and measuring actual input current flowing to the subgroups; and
a main controller integrated into the plurality of power control boards to communicate with the plurality of power control boards,
wherein, when actual input current measured by the current measuring units is fed back to the power control boards, the power control boards send the fed-back actual input current to the main controller, the main controller calculates a difference between reference input current and the actual input current to obtain a calibration value for each of the subgroups by comparing graph data of input voltage-reference input current with graph data of input current-actual input current and sends the calibration value to the corresponding power control boards, and the power control boards apply voltages to the corresponding subgroups according to the corresponding calibration values to uniformly heat a substrate during rapid heat treatment.

3. The apparatus of claim 2, wherein the current measuring units are current transformers.

4. The apparatus of claim 2, wherein the main controller and the power control boards send data to each other via controller area network (CAN) communication.
